(19) United States
(12) Patent Application Publication
(10) Pub. No.: US 2026/0208785 A1
(43) Pub. Date: Jul. 23, 2026

(54) STEER-BY-WIRE ENERGY STORAGE APPARATUS

(71) Applicant: Ford Global Technologies, LLC, Dearborn, MI (US)

(72) Inventor: Jonathan Craig Sullivan, Ferndale, MI (US)

(21) Appl. No.: 19/035,495

(22) Filed: Jan. 23, 2025

(51) Int. Cl. B62D 5/00

(52) U.S. Cl. CPC B62D 5/006

(57) ABSTRACT

Disclosed examples include a steering shaft; a clutch coupled to the steering shaft; a differential coupled to the steering shaft via the clutch; and a torque spring coupled to a carrier of the differential.

### FIELD OF THE DISCLOSURE

This disclosure relates generally to steering systems and, more particularly, to steer-by-wire energy storage apparatus.

### BACKGROUND

Vehicles include multiple subsystems to carry out various functions. A steering subsystem enables a vehicle operator to control the direction of movement of the vehicle. In a mechanical steering subsystem, a steering shaft extends from a steering wheel to a rack and pinion assembly or a steering box system between the two front wheels of the vehicle. As the vehicle operator turns or rotates the steering wheel, the rotational motion is transferred through the steering shaft and translated into a linear movement by the rack and pinion assembly or the steering box system. The linear movement controls a steering direction of the two front wheels.

### SUMMARY

An example apparatus includes a steering shaft, a clutch coupled to the steering shaft, a differential coupled to the steering shaft via the clutch, and a torque spring coupled to a carrier of the differential.

An example steer-by-wire system includes a steering wheel, a clutch coupled to the steering wheel, a differential coupled to the steering wheel via the clutch, a steering controller coupled to the steering wheel, and a road wheel actuator to communicate with the steering controller.

An example apparatus includes a differential having a differential carrier, a torque spring having a first end coupled to the differential carrier and a second end coupled to a structure separate from the differential carrier, the torque spring to receive energy from the differential carrier, the torque spring to store the energy, and a clutch coupled to the differential, the clutch to control transfer of the energy between a steering wheel and the torque spring.

### BRIEF DESCRIPTION OF THE DRAWINGS

FIG. 1 is a perspective view of a vehicle in which an example steer-by-wire (SBW) energy storage apparatus is implemented as part of a SBW system.

FIG. 2 is a system diagram of an example implementation of a SBW system including the SBW energy storage apparatus of FIG. 1.

FIG. 3A is a detailed diagram of the SBW energy storage apparatus of FIGS. 1 and 2.

FIG. 3B is an example front view of the constant torque spring of the SBW energy storage apparatus of FIG. 3A.

FIG. 4 is a detailed diagram of the clutch of the SBW energy storage apparatus of FIG. 3A.

FIG. 5 is a diagram including indicators of forces of the components of the SBW energy storage apparatus of FIGS. 1-3A for a counterclockwise (left) self-turn of a handwheel based on energy consumed from a constant torque spring and no driver-input hand resistance on the handwheel.

FIG. 6 is a diagram including indicators of forces of the components of the SBW energy storage apparatus of FIGS. 1-3 for a counterclockwise torque (torque to left) from the SBW energy storage apparatus to the handwheel while a driver's hands are fully resisting the handwheel.

FIG. 7 is a diagram including indicators of forces of the components of the SBW energy storage apparatus of FIGS. 1-3 when energy is absorbed by the constant torque spring based on a counterclockwise torque (torque to left) from the SBW energy storage apparatus to the handwheel that is less than a clockwise driver-input hand torque (torque to right) applied to the handwheel.

FIG. 8 is a diagram including indicators of forces of the components of the SBW energy storage apparatus of FIGS. 1-3 for a clockwise (right) self-turn of a handwheel based on energy consumed from a constant torque spring and no driver-input hand resistance on the handwheel.

FIG. 9 is a diagram including indicators of forces of the components of the SBW energy storage apparatus of FIGS. 1-3 for a clockwise torque (torque to right) from the SBW energy storage apparatus to the handwheel while a driver's hands are fully resisting the handwheel.

FIG. 10 is a diagram including indicators of forces of the components of the SBW energy storage apparatus of FIGS. 1-3 when energy is absorbed by the constant torque spring based on a clockwise torque (torque to right) from the SBW energy storage apparatus to the handwheel that is less than a driver-input counterclockwise hand torque (torque to left) applied to the handwheel.

FIG. 11 is a diagram including indicators of forces of the components of the SBW energy storage apparatus of FIGS. 1-3 when the SBW energy storage apparatus and the handwheel are in a neutral state.

FIG. 12 is an example handwheel speed to magnetorheological (MR) coil current graph that may be used to control the clutch of FIGS. 3-11.

In general, the same reference numbers will be used throughout the drawing(s) and accompanying written description to refer to the same or like parts. The figures are not necessarily to scale.

### DETAILED DESCRIPTION

Examples disclosed herein may be used to implement a SBW energy storage apparatus. An example SBW energy storage apparatus disclosed herein includes a MR clutch, a constant torque spring, and a differential that provide position and torque control. More particularly, examples disclosed herein provide position and torque control to a SBW system through use of the MR clutch and use of the constant torque spring mounted to a carrier of the differential.

In some SBW systems, a handwheel actuator includes two motors in a three-phase motor architecture or one motor in a six-phase motor architecture (e.g., two three-phase motors in one housing when controlled with two different controllers) to provide feedback to the driver, two or more control units, and sometimes a backup friction device in case motor damping is not sufficient if a motor of the SBW system is not functioning correctly. Other SBW systems do not have torque feedback or position control, and they primarily apply torque equal to or less than the torque created by a driver's hands. Such other SBW systems turn driver-input hand torque into friction/heat if they are creating less torque than the driver is applying.

In an SBW system, a driving input to a steering wheel (e.g., a handwheel) can be countered by a largely resistive torque from a torque feedback mechanism of the SBW system. Occasionally, based on the cross-slope of the road or autonomous functions like quiet wheel (e.g., a vehicle driving mode in which autonomous steering of a vehicle does not produce corresponding movement of the steering wheel), the SBW system applies non-resistive torque back to the steering wheel and moves the steering wheel to a specific position. This can be done with a motor. However, a motor-based implementation of a SBW system requires a sufficient number of backup motors even though the steering wheel turns, at most, 540 degrees in either direction with a fairly low torque and moderate power requirements.

Example SBW systems disclosed herein use a constant torque spring (e.g., a constant force spring) that has sufficient torque to satisfy a maximum torque requirement of a SBW system and that stores energy when resisting driver input at the steering wheel. Disclosed example SBW systems use the stored energy of the constant torque spring to provide position control or torque in the same direction of driver input.

In examples disclosed herein, the MR clutch is used to actuate a gearing system. The gearing system dictates the direction of torque applied to the steering wheel and whether work is being done on the driver's hands by the constant torque spring or whether input torque applied on the steering wheel by a driver's hands is doing work on the constant torque spring. In examples disclosed herein, the MR clutch is used to control power flow in both clockwise and counterclockwise directions of a steering wheel and hold the constant torque spring in place during a neutral position of the steering wheel. In examples disclosed herein, such neutral position is also referred to as geared neutral in which the constant torque spring feels a locked condition and the input gearing of the gearing system experiences an infinite torque sink. Accordingly, examples disclosed herein provide a torque feedback mechanism to a steering wheel of a SBW system. This torque feedback mechanism provides resistive torque in response to inputs to the steering wheel by a driver's hands.

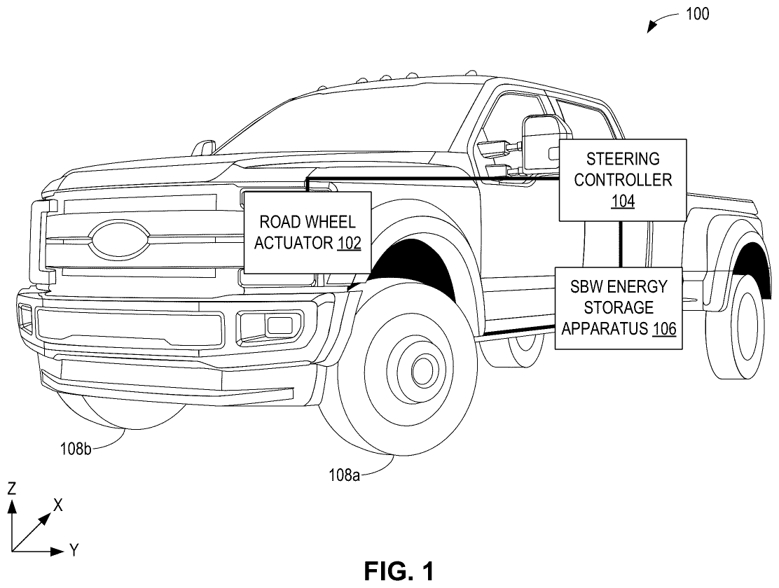

FIG. 1 is a perspective view of a vehicle 100 in which examples disclosed herein can be implemented. In the illustrated example of FIG. 1, the vehicle 100 includes an example road wheel actuator 102, an example steering controller 104, and an example SBW energy storage apparatus 106. The vehicle 100 is a wheel-driven vehicle. In the illustrated example of FIG. 1, the vehicle 100 is a pick-up truck. In other examples, the vehicle 100 can be any type of wheeled vehicle (e.g., a sedan, a coupe, a van, a sports utility vehicle, an all-terrain vehicle (ATV), farming equipment, etc.). In some examples, the vehicle 100 includes an internal combustion engine (e.g., a non-electrified vehicle, a partially electrified vehicle, etc.). In other examples, the vehicle 100 is a fully electric vehicle.

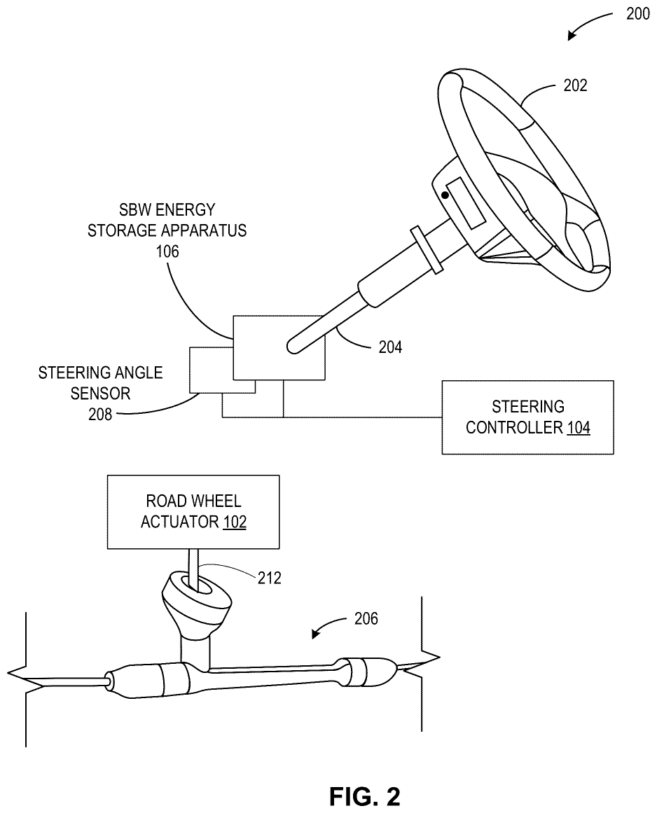

In the example of FIG. 1, the road wheel actuator 102 and the steering controller 104 implement a SBW system (e.g., the SBW system 200 of FIG. 2). One or both of the road wheel actuator 102 and the steering controller 104 may be implemented as programmable circuitry. The road wheel actuator 102 allows a user of the vehicle 100 to control/steer front wheels 108a, b of the vehicle 100. In other examples, the road wheel actuator 102 (or a separate road wheel actuator) allows a user of a vehicle 100 to also control/steer rear wheels of a four-wheel steer vehicle 100. In the illustrated example of FIG. 1, the road wheel actuator 102 and the steering controller 104 include corresponding communication interfaces (e.g., wired or wireless interfaces) to communicate control information and feedback between the road wheel actuator 102 and the steering controller 104.

The steering controller 104 controls and/or manages the road wheel actuator 102. For example, the steering controller 104 can calculate a rotational angle of the road wheel actuator 102 based on a rotational angle of a steering wheel (e.g., the steering wheel 202 of FIG. 2) controlled by a vehicle operator. In some examples, some or all of the steering controller 104 can be implemented by an electronic control unit (ECU) of the vehicle 100. In other examples, the steering controller 104 can be implemented by another suitable computer (e.g., another computer of the vehicle 100, a mobile device of a user of the vehicle 100, a remote computer, etc.).

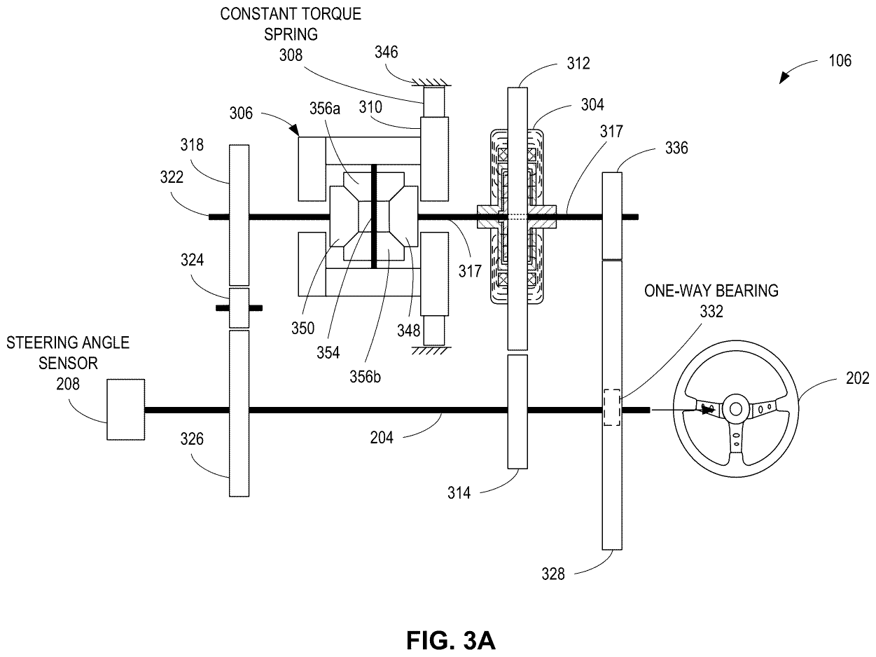

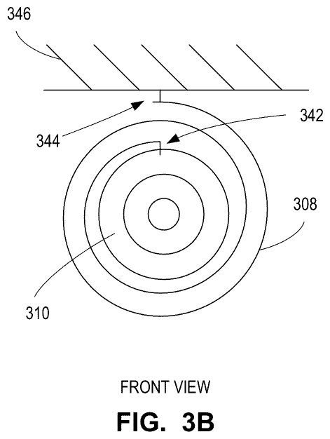

The steering controller 104 is in circuit with the SBW energy storage apparatus 106. For example, the SBW energy storage apparatus 106 includes a clutch (e.g., the clutch 304 of FIG. 3A) that receives electrical signals from the steering controller 104 to control power flow in clockwise and counterclockwise directions of a steering wheel and to hold a constant torque spring (e.g., the constant torque spring 308 of FIGS. 3A and 3B) in place during a neutral position. The SBW energy storage apparatus 106 is described in detail below in connection with FIG. 3A.

FIG. 2 is a system diagram of an example SBW system 200 that includes the road wheel actuator 102, the steering controller 104, and the SBW energy storage apparatus 106 of FIG. 1. The SBW system 200 also includes an example steering wheel 202, an example steering shaft 204, an example rack and pinion system 206, and an example steering angle sensor 208. The rack and pinion system 206 is coupled to the front wheels 108a, b of the vehicle 100 (FIG. 1). In other examples, the rack and pinion system 206 is coupled to the rear wheels of a four-wheel steer vehicle 100. In the example of FIG. 2, the steering controller 104 and the SBW energy storage apparatus 106 implement a handwheel actuator (HWA) subsystem of the SBW system 200.

The steering wheel 202 is coupled to the steering shaft 204 and allows a user of the vehicle 100 to operate the road wheel actuator 102 and thereby steer the vehicle 100. To do so, the steering controller 104 is in communication with the road wheel actuator 102. For example, the steering controller 104 includes a transceiver (e.g., a wireless or wired transceiver) that is in communication with a transceiver (e.g., a wireless or wired transceiver) of the road wheel actuator 102. As such, the steering controller 104 can transmit driver inputs (e.g., rotating the steering wheel 202) from the steering wheel 202 as steering control signals (e.g., steering commands) to the road wheel actuator 102 and the steering controller 104 can receive vehicle handling feedback from the road wheel actuator 102. The steering wheel 202 includes an interface (e.g., handgrips, etc.) that enables a user to apply torque to the steering shaft 204 as driver input to the SBW energy storage apparatus 106. For example, as the user turns the steering wheel 202, the rotational torque of the steering wheel 202 is transferred through the steering shaft 204 to the SBW energy storage apparatus 106.

In the illustrated example of FIG. 2, the steering shaft 204 is coupled to the SBW energy storage apparatus 106 and to the steering angle sensor 208. The steering angle sensor 208 senses steering angles (e.g., rotational positions) of the steering shaft 204 and generates corresponding signals representative of rotational positions of the steering wheel 202. Accordingly, the signals generated by the steering angle sensor 208 can be used by the steering controller 104 to transmit steering control signals to the road wheel actuator 102. In addition to determining steering angles of the steering wheel 202, the steering angle sensor 208 may be used to derive other steering-related metrics such as steering velocity, steering acceleration, steering torque, etc.

The rack and pinion system 206 is a linear actuator that includes a pinion engaged with a rack. The rack and pinion system 206 translates rotational inputs from the road wheel actuator 102 into linear motion to steer the wheels 108a, b (FIG. 1). In this manner, a user operating the steering wheel 202 causes the rack and pinion system 206 to change directions of the vehicle 100 by steering the wheels 108a, b.

Although not shown, the road wheel actuator 102 also includes a rotation sensor substantially similar or identical to the steering angle sensor 208. The rotation sensor can be coupled to a wheel-steering shaft 212, which is coupled to the rack and pinion system 206. Based on such a configuration, the road wheel actuator 102 can use its rotation sensor to detect road-wheel feedback (e.g., vehicle handling feedback) from the wheels 108a, b and communicate that road-wheel feedback to the steering controller 104 so that the steering controller 104 can provide the feedback to a driver via the steering wheel 202.

FIG. 3A is a detailed diagram of the SBW energy storage apparatus 106 of FIGS. 1 and 2. The SBW energy storage apparatus 106 shows the steering shaft 204 of FIG. 2 coupled between the steering wheel 202 and the steering angle sensor 208. In examples disclosed herein, coupled refers to being directly or indirectly coupled or operatively coupled. For example, a component may be directly coupled to another component in that both components are in contact with one another. In another example, two components may be indirectly coupled to one another in that there is one intermediary component or multiple intermediary components between the two indirectly coupled components. In yet another example, a first component may be operatively coupled to a second component in that a force, function, and/or action acting on the first component affects the second component by creating a causal effect of a resulting force, function, and/or action that acts on the second component.

Turning in detail to FIG. 3A, the SBW energy storage apparatus 106 includes an example clutch 304, an example differential 306, and an example constant torque spring 308 (e.g., a constant force spring). The differential 306 includes an example differential carrier 310. The clutch 304 is coupled to the steering shaft 204. As such, the clutch 304 is also coupled to the steering wheel 202. For example, an example spur gear 312 of the SBW energy storage apparatus 106 is coupled to the clutch 304, another example spur gear 314 of the SBW energy storage apparatus 106 is coupled to the steering shaft 204, and the clutch 304 is coupled to the steering shaft 204 by the spur gear 312 of the clutch 304 meshing with the spur gear 314 of the steering shaft 204. In examples disclosed herein, the spur gear 312 is referred to as being clutched to the clutch 304 because the spur gear 312 rotates in accordance with different amounts of clutch resistance or damping force created by the clutch 304. In the illustrated example, the spur gear 312 may be secured onto the clutch 304 and the spur gear 314 may be secured onto the steering shaft 204 using any suitable gear securing technique (e.g., press fit; keyway, key, and set screw; welded, etc.). Similarly, other gears of the SBW energy storage apparatus 106 may be secured to their corresponding shafts using any suitable gear securing technique.

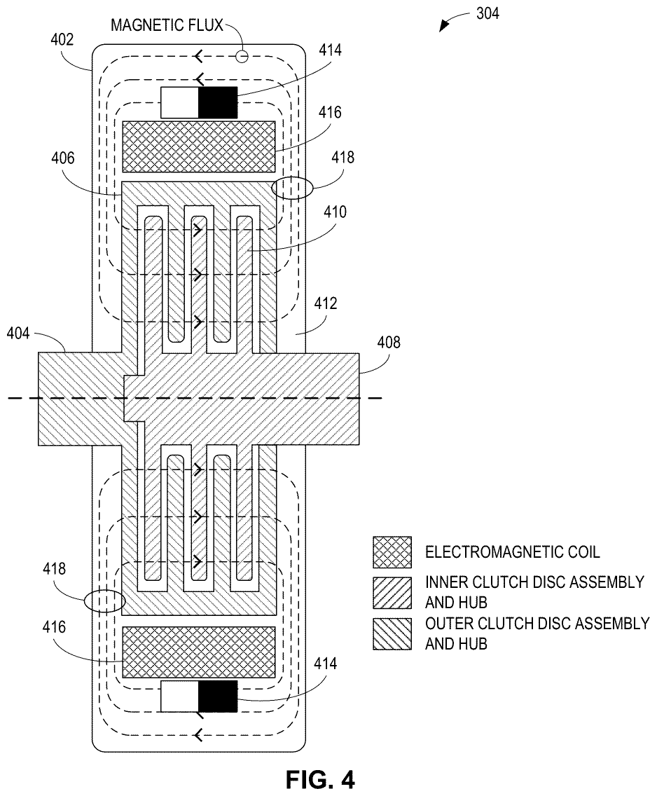

The clutch 304 is also coupled to the differential 306 and is provided to control the amount of torque or energy that is transferred between the steering wheel 202 and the constant torque spring 308. To control the amount of torque transfer, the steering controller 104 of FIGS. 1 and 2 is in circuit with the clutch 304. For example, the steering controller 104 may be electrically coupled to the clutch 304 to provide electrical signals that cause the clutch 304 to increase and decrease clutch resistance or damping force. For example, the torque resistance provided by the clutch 304 is varied by the steering controller 104 supplying different voltage levels and/or electrical current levels to the clutch 304. Accordingly, the clutch 304 can control how much feedback torque from the constant torque spring 308 is fed back to the steering wheel 202. In examples disclosed herein, a fully disengaged or unlocked clutch 304 feeds back the least torque to the spur gear 314. When the constant torque spring 308 is compressed to store energy, increasing the engagement of the clutch 304 increases the amount of feedback torque to the spur gear 314 from the constant torque spring 308. Accordingly, the amount of engagement of the clutch 304 determines how much torque or power flow is transferred through either the set of gears 312, 314 (e.g., a first gear set) or a set of gears 328, 336 (e.g., a second gear set) to the steering wheel 202. The clutch 304 is described in more detail below in connection with FIG. 4.

The differential 306 is coupled to the steering shaft 204 via the clutch 304. As such, the differential 306 is also coupled to the steering wheel 202. For example, a first end of the differential 306 is coupled to the steering shaft 204 via the clutch 304 which is coupled to the steering shaft 204 as described above. In the example of FIG. 3A, an example first differential transfer shaft 317 extends from the first end of the differential 306 to the clutch 304. In the illustrated example, the first differential transfer shaft 317 is a through-shaft that extends through the clutch 304 and the clutch 304 is coupled to the first differential transfer shaft 317.

A second end of the differential 306 is coupled to the steering shaft 204 via an example spur gear 318, an example second differential transfer shaft 322, an example idler gear 324, and an example spur gear 326. For example, the second differential transfer shaft 322 extends from the second end of the differential 306, and the spur gear 318 is secured onto the second differential transfer shaft 322. The idler gear 324 is meshed with the spur gear 318, and the spur gear 326 is coupled to the steering shaft 204 and meshed with the idler gear 324.

The SBW energy storage apparatus 106 includes an example free-wheel spur gear 328, an example one-way bearing 332, and an example spur gear 336. The one-way bearing 332 couples the free-wheel spur gear 328 to the steering shaft 204 to allow the free-wheel spur gear 328 to overrun or underrun the steering shaft 204. For example, the free-wheel spur gear 328 is referred to as “free-wheel” because the one-way bearing 332 allows the free-wheel spur gear 328 to rotate independent of the steering shaft 204 in one direction (e.g., overrun the steering shaft 204) and rotate in unison with the steering shaft 204 in the other direction (e.g., underrun the steering shaft 204). The first differential transfer shaft 317 extends between the spur gear 336 and the clutch 304. For example, the first differential transfer shaft 317 is coupled to the clutch 304 and extends from the clutch 304. The spur gear 336 is coupled to the first differential transfer shaft 317 and meshed with the free-wheel spur gear 328.

The constant torque spring 308 is coupled to the differential carrier 310 of the differential 306. In examples disclosed herein, the differential carrier 310 (e.g., a carrier) is a housing of the differential 306. In examples disclosed herein, the constant torque spring 308 is a spring that receives or absorbs rotational kinetic energy and releases the energy to produce a constant torque or constant force output over time. An example front view of the constant torque spring 308 in FIG. 3B shows that the constant torque spring 308 has a first spring end 342 coupled to the differential carrier 310 and a second spring end 344 coupled to a structure, such as a fixed surface 346, separate from the differential carrier 310. For example, the fixed surface 346 may be a housing of the SBW energy storage apparatus 106 or any other surface that is fixed relative to the differential carrier 310 of the differential 306. In examples disclosed herein, the constant torque spring 308 receives or absorbs rotational kinetic energy from the differential carrier 310 as the differential carrier 310 rotates about the shafts 322, 317 based on steering inputs from the steering wheel 202 and the steering shaft 204. When the spring ends 342, 344 of the constant torque spring 308 are held stationary relative to one another after compression of the constant torque spring 308, the constant torque spring 308 stores absorbed energy. When the spring end 342 is allowed to move relative to the other spring end 344 to decompress the constant torque spring 308, the constant torque spring 308 releases the stored energy, urging the differential carrier 310 to a neutral position (e.g., when the constant torque spring 308 has released its energy and is not storing a substantial amount of energy).

In the example of FIG. 3A, the differential 306 is driven by the differential transfer shafts 317, 322 which are connected to corresponding example spider gears 348, 350 of the differential 306. Also, in the example of FIG. 3A, the spur gear 314 and the spur gear 312 form a first gear set, and the free-wheel spur gear 328 and the spur gear 336 form a second gear set. In some examples, gear ratios of the first and second gear sets are chosen so that a gear ratio (e.g., a 2:1 gear ratio) of the first gear set is higher than a gear ratio (e.g., a 1:1 gear ratio) between the spur gear 318 and the spur gear 326 and so that a gear ratio (e.g., a 1:2 gear ratio) of the second gear set is lower than the gear ratio (e.g., a 1:1 gear ratio) of the spur gear 318 and the spur gear 326. In some examples, a gear ratio greater than 1:1 could be selected for the first gear set so that the spider gear 350 overcomes the spider gear 348 to compress the constant torque spring 308, thereby storing energy in the constant torque spring 308. For example, a gear ratio of the spur gear 312 to the spur gear 314 could be 2:1 so that a half of a rotation of the spur gear 312 results in one full rotation of the spur gear 314, thereby causing the spider gear 350 to rotate faster than the spider gear 348.

In the example of FIG. 3A, the differential 306 includes an example link shaft 354 and example side gears 356a, b secured to the link shaft 354. The side gears 356a, b are meshed between the spider gears 348, 350 to transfer rotational motion between the spider gears 348, 350. In the SBW energy storage apparatus 106, the directions of rotation between the spider gear 350 and the link shaft 354 are chosen so that power recirculation is possible. The idler gear 324 is provided between the spur gear 318 and the spur gear 326 to allow such changes in directions of rotation. The clutch 304 ties or clutches the spur gear 312 to the first differential transfer shaft 317 when the clutch 304 is fully locked. The one-way bearing 332 allows the free-wheel spur gear 328 to overrun the steering shaft 204 when the clutch 304 is fully actuated (e.g., fully locked).

FIG. 4 is a detailed diagram of the clutch 304 of the SBW energy storage apparatus 106 of FIG. 3A. In the example of FIG. 4, the clutch 304 is an MR clutch. However, any other suitable type of clutch may be used to implement the clutch 304. The clutch 304 is to receive a voltage (e.g., from the steering controller 104 of FIGS. 1 and 2) to control a damping force created by the clutch 304. The damping force is to control the transfer of energy (e.g., through rotational torque) between the steering wheel 202 and the constant torque spring 308. Although the clutch 304 is described as voltage-controlled, the clutch 304 may additionally or alternatively be controlled based on driving different amounts of electrical current to the clutch 304.

In examples disclosed herein, the clutch 304 has an example clutch housing 402, an example first hub 404, an example outer clutch disc assembly 406, an example second hub 408, an example inner clutch disc assembly 410, an example MR fluid 412, an example permanent magnet 414, and an example electromagnetic coil 416. The first hub 404 is coupled to or integrally formed with the outer clutch disc assembly 406. The second hub 408 is coupled to or integrally formed with the inner clutch disc assembly 410. The first hub 404 extends from the outer clutch disc assembly 406 and protrudes from the clutch housing 402. The second hub 408 extends from the inner clutch disc assembly 410 and protrudes from the clutch housing 402 in a direction opposite the first hub 404. In the example of FIG. 4, the clutch housing 402 is fixed to the first hub 404 and the spur gear 312 is secured onto the clutch housing 402 so that the clutch housing 402 rotates in unison with the first hub 404 and the spur gear 312 regardless of a fully locked or fully unlocked state of the clutch 304. In addition, the second hub 408 is fixedly coupled to the first differential transfer shaft 317 (e.g., via a set screw, a weld, etc.). Accordingly, the second hub 408 rotates in unison with the first differential transfer shaft 317 regardless of a fully locked or fully unlocked state of the clutch 304. In addition, the second hub 408 and the first differential transfer shaft 317 rotate freely relative to (or independent of) the clutch housing 402 and the first hub 404 when the clutch 304 is fully unlocked or disengaged and rotate in unison with the clutch housing 402 and the first hub 404 when the clutch 304 is fully locked or engaged.

The clutch housing 402 holds the MR fluid 412. The MR fluid 412 has magnetic properties that cause a viscosity of the MR fluid 412 to increase and decrease commensurate with an electrical current applied to the MR fluid 412 (e.g., in the form of electromagnetic fields from the permanent magnet 414 and/or the electromagnetic coil 416). As the viscosity of the MR fluid 412 increases towards a solid state, the fluid clutches or binds the outer clutch disc assembly 406 to the inner clutch disc assembly 410 to increase the transfer of rotational torque between the first hub 404 and the second hub 408. Decreasing the viscosity of the MR fluid 412 decreases the binding or clutching between the outer clutch disc assembly 406 and the inner clutch disc assembly 410 to decrease the transfer of rotational torque between the first hub 404 and the second hub 408.

The clutch 304 includes the permanent magnet 414 to create permanent magnetic (PM) fields 418 equal to the torque required to achieve geared neutral between the first differential transfer shaft 317 and the spur gear 312. The permanent magnet 414 may be implemented as a ring or toroid structure around the clutch disc assemblies 406, 410 or as multiple magnets in an annular arrangement around the clutch disc assemblies 406, 410. The permanent magnet 414 is manufactured to a fixed strength that helps align the PM fields 418 in the MR fluid 412 to increase/decrease the clutch resistance of the clutch 304. The magnet strength of the permanent magnet 414 is selected to produce an amount of viscosity in the MR fluid 412 that sufficiently clutches or binds the outer clutch disc assembly 406 to the inner clutch disc assembly 410 to create equilibrium torque when the constant torque spring 308 is intended to not apply any force on the steering wheel 202. In examples disclosed herein, such equilibrium torque refers to a state in which the constant torque spring 308 neither absorbs torque force from the steering wheel 202 nor adds torque force to the steering wheel 202.

The electromagnetic coil 416 is electrically coupled to the steering controller 104 of FIGS. 1 and 2. The steering controller 104 provides electrical signals to the electromagnetic coil 416 to create a switchable electric field to either increase the PM field 418 or counteract the PM field 418. When no voltage is supplied to the clutch 304, the clutch 304 spins against torque based on the PM fields 418 created by the permanent magnet 414. Under this condition, the differential carrier 310 is locked in a geared neutral state.

In examples disclosed herein, to fully disengage or unlock the clutch 304, the steering controller 104 provides sufficient electrical current to the electromagnetic coil 416 to create an electric field that is opposite in polarity and equal in magnitude to the PM field 418 created by the permanent magnet 414. This equal-magnitude and opposite-polarity electric field cancels or neutralizes the strength of the PM field 418 so that the MR fluid 412 has the least viscosity and the outer clutch disc assembly 406 and the inner clutch disc assembly 410 are not bound or clutched to one another. In examples disclosed herein, to fully engage or lock the clutch 304, the steering controller 104 provides sufficient electrical current to the electromagnetic coil 416 to create an electric field of the same polarity as the PM field 418 created by the permanent magnet 414 to fully clutch or bind the outer clutch disc assembly 406 to the inner clutch disc assembly 410 so that the outer clutch disc assembly 406 and the inner clutch disc assembly 410 rotate in unison. In examples disclosed herein, to create equilibrium torque via the clutch 304, the steering controller 104 does not provide any electrical current to the electromagnetic coil 416 so that the viscosity of the MR fluid 412 is based solely on strength of the PM field 418 created by the permanent magnet 414.

Using the combination of the permanent magnet 414 and the electromagnetic coil 416 in this manner reduces (e.g., by half) the voltage and current used by an MR clutch implementation of the clutch 304 relative to not using the permanent magnet 414. That is, the PM field 418 serves to create a default level of viscosity in the MR fluid 412 (and thereby an amount of clutching of the clutch 304) to achieve equilibrium torque that would otherwise need to be created by applying higher electrical power to the electromagnetic coil 416. In addition, the use of the permanent magnet 414 in the clutch 304 is to substantially reduce or eliminate the amount of force exerted on the steering wheel 202 by the constant torque spring 308 in the event electrical power is removed. The permanent magnet 414 is also to provide an internal torque sink which can be designed to satisfy redundancy criteria.

Providing the clutch 304 in combination with the one-way bearing 332 as shown in FIG. 3A allows the clutch 304 to resist the second gear set (e.g., the free-wheel spur gear 328 and the spur gear 336) up until a point where the first gear set (e.g., the spur gear 312 and the spur gear 314) forces the free-wheel spur gear 328 to overrun the one-way bearing 332. This gives a large range of ratios and, thus, a large range of torques that can be instantly applied to the steering wheel 202 due to the reaction time of the clutch 304. This is commensurate with the performance of feedback motors that are used in other SBW systems. However, unlike such other SBW systems, the SBW energy storage apparatus 106 replaces such feedback motors to substantially reduce or eliminate electrical power consumption that would otherwise be used by such feedback motors. This, in turn, decreases load on a vehicle's battery(ies) and/or alternator.

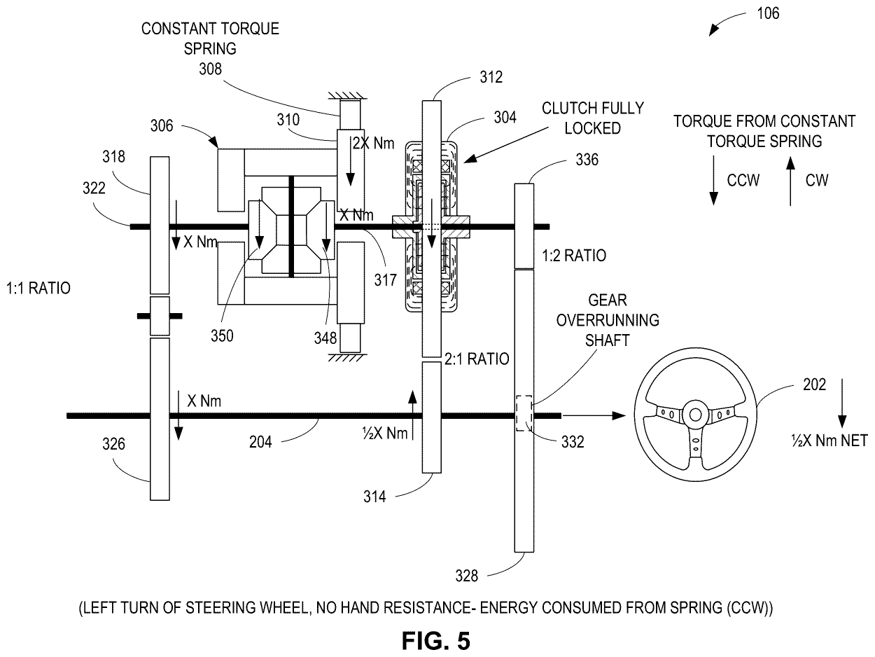

FIGS. 5-11 are diagrams including indicators of forces of the components of the SBW energy storage apparatus 106 of FIGS. 1-3 for different steering or non-steering scenarios. In the examples of FIGS. 5-11, downward pointing arrows correspond to counterclockwise (CCW) rotations and upward pointing arrows correspond to clockwise (CW) rotations. Also in the examples of FIGS. 5-11, solid-line arrows represent torques released from the constant torque spring 308 as feedback to the steering wheel 202 and dashed-line arrows represent torques from driver inputs to the steering wheel 202 that result in energy stored by the constant torque spring 308. In the descriptions of some examples below, torques released from the constant torque spring 308 are referred to as feedback torques because they contribute to generating feedback torques at the steering wheel 202.

In the examples of FIGS. 5-11, “×” represents a value of torque which is measured in Newton-meter (Nm) units. As such, an amount of torque is represented as “× Nm”. Also in the examples of FIGS. 5-11, a numeric multiplier value appears before the “×” torque value in some places to represent a multiplication of the torque to either increase or decrease the resulting torque of a component. When a multiplier of “1” is noted or no multiplier is noted, the torque is represented by the value of “×” (e.g., without an increase or decrease).

In some of the examples of FIGS. 5-11, rate of angular rotation is expressed in terms of radians per second (rad/s). One radian in degrees of angular rotation is equal to 180/π. Rate of angular rotation is shown as “Y rad/s”. In some places, a numeric multiplier value appears before the “Y” rate of angular rotation value to represent a multiplication of the rate of angular rotation to either increase or decrease the resulting rate of angular rotation of a component. In examples disclosed herein, the differential carrier 310 rotates or spins about the differential transfer shafts 317, 322 at speeds (rad/s) that are based on rotational inputs received via both of the differential transfer shafts 317, 322. In examples disclosed herein, a speed (rad/s) of the differential carrier 310 is the average of the input speeds (rad/s) of the differential transfer shafts 317, 322.

In the examples of FIGS. 5-11, the gear ratio between the spur gear 318 and the spur gear 326 is 1:1, the gear ratio between the spur gear 312 and the spur gear 314 is 2:1, and the gear ratio between the spur gear 336 and the free-wheel spur gear 328 is 1:2. However, any other suitable gear ratios may be selected. The gear ratios and the principle that larger gears produce more torque than smaller gears affect amounts of torque transferred between the steering wheel 202 and the constant torque spring 308.

The examples of FIGS. 5-11 are only some example states of the SBW energy storage apparatus 106. In operation, the SBW energy storage apparatus 106 may transition through many other states in which the components of the SBW energy storage apparatus 106 operate in different directions, with different torques, and/or with different rates of angular rotation. The components of the SBW energy storage apparatus 106 disclosed herein are configured so that their torques and rotations adjust relative to one another in a fluid manner during steering operations to absorb energy in the constant torque spring 308 from driver input torque via the steering wheel 202 and to provide desired feedback torque to a driver back through the steering wheel 202. In the below descriptions of FIGS. 5-11, the values of torques (e.g., × Nm), rates of angular rotation (Y rad/s), and gear ratios are merely examples. Any other suitable values may be used instead of or in combination with examples disclosed herein to suit particular applications. In addition, the example values provided in this disclosure are approximations, recognizing that variations may occur in real-world applications. For example, actual values may not be exact due to manufacturing tolerances and/or other real-world imperfections as will be understood by persons of ordinary skill in the art. For example, actual values may be within a tolerance range of +/−10% relative to values provided in this disclosure unless otherwise specified herein.

In the examples of FIGS. 5-7, the clutch 304 is fully locked (e.g., fully engaged) which causes the free-wheel spur gear 328 to overrun the steering shaft 204 based on the one-way bearing 332. For example, the clutch 304 can be fully locked based on the steering controller 104 delivering a control voltage to the clutch 304 to create a switchable electric field via the electromagnetic coils 416. This switchable electric field increases the PM field 418 to increase the viscosity of the MR fluid 412 and fully lock or engage the clutch disc assemblies 406, 410 to one another.

FIG. 5 is a diagram including indicators of forces of the components of the SBW energy storage apparatus 106 of FIGS. 1-3 for a CCW (left) self-turn of the steering wheel 202 based on energy consumed from (e.g., released by) the constant torque spring 308 and no driver-input hand resistance on the steering wheel 202. In the example of FIG. 5, the constant torque spring 308 has stored energy which creates a feedback CCW 2× Nm torque on the differential carrier 310. The fully locked clutch 304 causes the first differential transfer shaft 317 and the second differential transfer shaft 322 to rotate (or spin) at the same rate. This produces feedback CCW × Nm torques at the spider gears 348, 350 which is shown by the downward pointing CCW arrows.

The 1:1 gear ratio between the spur gear 318 and the spur gear 326 causes the feedback CCW × Nm torque of the spider gear 350 to be transferred as CCW×NM torque from the spur gear 318 to the spur gear 326. The 2:1 gear ratio between the spur gear 312 and the spur gear 314 causes the feedback CCW × Nm torque from the spider gear 348 to decrease to half the torque (e.g., ½× Nm) at the spur gear 314 in the CW direction. Although the spur gear 326 and the spur gear 314 rotate in the same direction, the CW ½× Nm torque of the spur gear 314 is in the opposite direction of the CCW × Nm torque of the spur gear 326 as the torques of the spur gears 314 and 326 resist one another. In the illustrated example, the opposing torques of the spur gear 314 and the spur gear 326 produce a feedback ½× Nm torque in the CCW direction at the steering shaft 204. The steering shaft 204 transfers the feedback CCW ½× Nm torque to the steering wheel 202. In the example of FIG. 5, applying the feedback torque originating from the constant torque spring 308 to the steering wheel 202 in the CCW direction turns the steering wheel 202 to the left as feedback to a driver that the vehicle 100 is straightening its front wheels 108a, b such as when coming out of a right turn and returning towards a straight path of travel.

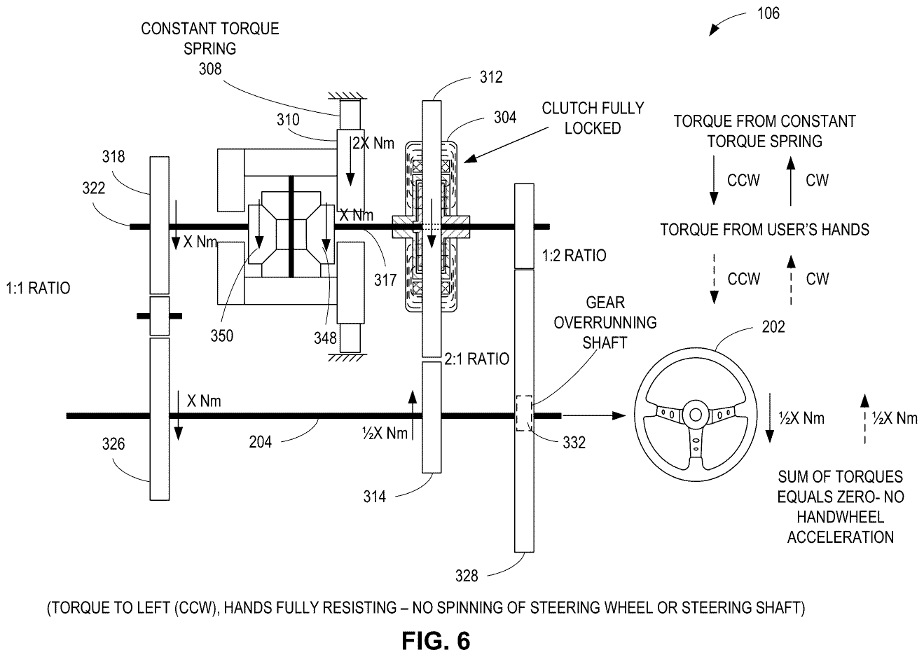

FIG. 6 is a diagram including indicators of forces of the components of the SBW energy storage apparatus 106 of FIGS. 1-3 for a feedback CCW torque (torque to left) based on energy consumed from (e.g., released by) the constant torque spring 308 to the steering wheel 202 while a driver's hands are fully resisting the steering wheel 202. In the example of FIG. 6, the constant torque spring 308 has stored energy which creates a feedback CCW 2× Nm torque on the differential carrier 310. The fully locked clutch 304 causes the first differential transfer shaft 317 and the second differential transfer shaft 322 to rotate (or spin) at the same rate. This produces a feedback CCW × Nm torque at the spider gears 348, 350.

The 1:1 gear ratio between the spur gear 318 and the spur gear 326 causes the feedback CCW × Nm torque of the spider gear 350 to transfer as CCW × Nm torque from the spur gear 318 to the spur gear 326. The 2:1 gear ratio between the spur gear 312 and the spur gear 314 causes the feedback CCW × Nm torque from the spider gear 348 to decrease to half the torque (e.g., ½× Nm) at the spur gear 314. Although the spur gear 326 and the spur gear 314 rotate in the same direction, the CW ½× Nm torque of the spur gear 314 is in the opposite direction of the CCW × Nm torque of the spur gear 326 as the torques of the spur gears 314 and 326 resist one another. In the illustrated example, the opposing torques of the spur gear 314 and the spur gear 326 produce a feedback ½× Nm torque in the CCW direction at the steering shaft 204. The steering shaft 204 transfers the feedback CCW ½× Nm torque to the steering wheel 202. In the example of FIG. 6, the steering shaft 204 applying the feedback torque in the CCW direction to the steering wheel 202 creates a feedback force against the steering wheel 202 to the left. However, this feedback CCW torque that originates from the constant torque spring 308 is counteracted by an equal and opposite driver-input hand torque applied by the driver to the steering wheel 202 which is shown in the example of FIG. 6 as a CW ½× Nm torque. As such, the sum of the torques applied to the steering wheel 202 equals zero (e.g., CCW ½× Nm torque+CW ½× Nm torque=0) and there is no acceleration of the steering wheel 202.

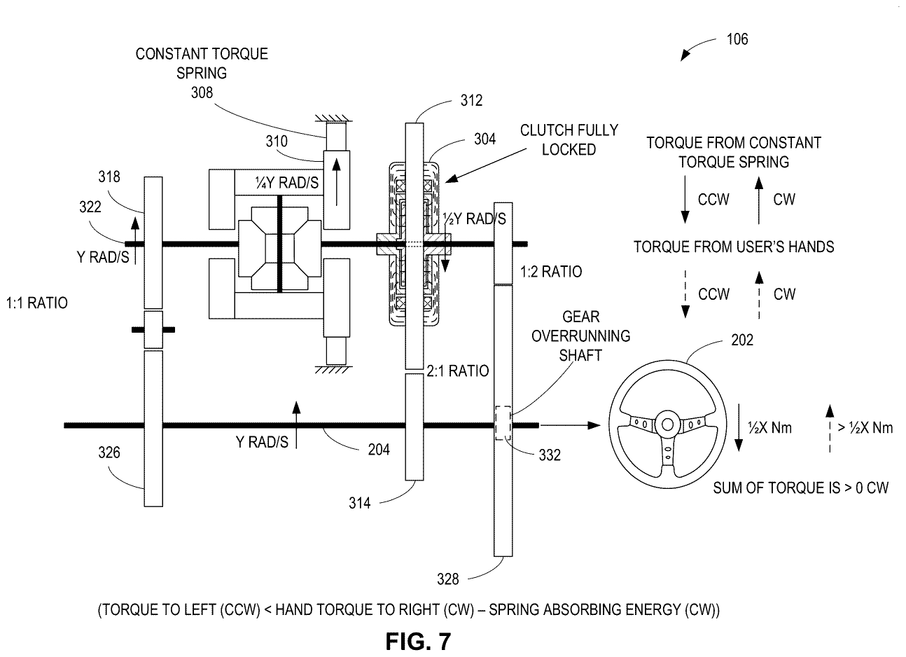

FIG. 7 is a diagram including indicators of forces of the components of the SBW energy storage apparatus 106 of FIGS. 1-3 when energy is absorbed by the constant torque spring 308 based on a feedback CCW torque (torque to left) from the SBW energy storage apparatus 106 to the steering wheel 202 that is less than a driver-input CW hand torque (torque to right) applied to the steering wheel 202. In the example of FIG. 7, the energy absorbed and stored by the constant torque spring 308 is described relative to rotations (e.g., rad/s) of the differential carrier 310 and other components of the SBW energy storage apparatus 106.

As the constant torque spring 308 is compressed based on the CW driver-input hand torque, the constant torque spring 308 produces torque in the opposite direction based on its mechanical resistance to the compression. This counteracting torque from the constant torque spring 308 propagates through the SBW energy storage apparatus 106 to transfer a feedback CCW ½× Nm torque to the steering wheel 202. However, the feedback CCW ½× Nm torque, which originates from mechanical resistance of the constant torque spring 308, is overcome by the CW driver-input hand torque which is shown to be greater than ½× Nm (e.g., >½× Nm). This makes the sum of the torques at the steering wheel 202 to be greater than zero in the CW direction (e.g., sum of torque>0 CW at steering wheel). As such, the CW driver-input hand torque on the steering wheel 202 causes the constant torque spring 308 to move into a compressed state in which the constant torque spring 308 stores energy. In other words, the constant torque spring 308 causes up to ½× Nm torque to be applied as CCW feedback to the steering wheel 202 before the constant torque spring 308 moves into the compressed state.

For CW driver-input hand torques on the steering wheel 202 that are greater than the feedback CCW ½× Nm torque from the mechanical resistance of the constant torque spring 308, a driver controls the angle/speed (e.g., rad/s) of the steering wheel 202 as the CW driver-input hand torque works against the inertia of the gears, shafts, and steering wheel 202 that resist further rotation. As shown in the example of FIG. 7, a driver-input hand torque on the steering wheel 202 that is greater than ½× Nm in the CW direction (e.g., a right turn) produces a CW rotation of Y rad/s at the steering shaft 204. The 2:1 gear ratio between the spur gear 312 and the spur gear 314 causes the CW rotation of Y rad/s from the steering shaft 204 to decrease to ½Y rad/s at the clutch 304. The 1:1 gear ratio between the spur gear 318 and the spur gear 326 causes the CW rotation of Y rad/s from the steering shaft 204 to transfer as Y rad/s to the spur gear 318. The difference between the CW rotation of Y rad/s at the spur gear 318 and the CCW rotation of ½Y rad/s at the clutch 304 produces a CW rotation of ¼Y rad/s at the differential carrier 310. This rotation of the differential carrier 310 compresses the constant torque spring 308 causing the constant torque spring 308 to store energy.

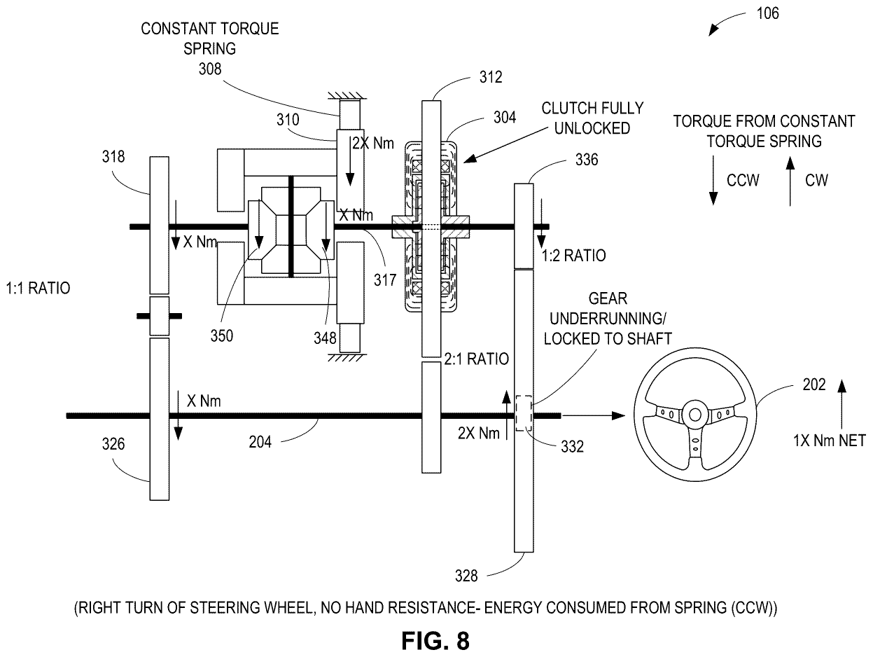

In the examples of FIGS. 8-10, the clutch 304 is fully unlocked (e.g., fully disengaged). This causes the free-wheel spur gear 328 to underrun the steering shaft 204 based on the one-way bearing 332. As such, the free-wheel spur gear 328 is in a locked relationship with the steering shaft 204 and rotates with the steering shaft 204. In addition, the fully unlocked clutch 304 allows the spur gear 336 to rotate independent of the first differential transfer shaft 317 and the spider gear 348. In the examples of FIGS. 8-10, the clutch 304 is fully unlocked based on the steering controller 104 providing sufficient electrical current to the electromagnetic coil 416 of the clutch 304 to create an electric field that is opposite in polarity and equal in magnitude to the PM field 418 created by the permanent magnet 414 of the clutch 304. This equal-magnitude and opposite-polarity electric field cancels or neutralizes the strength of the PM field 418 so that the MR fluid 412 in the clutch 304 has the least viscosity. This decrease in the viscosity of the MR fluid 412 fully unlocks or disengages the clutch disc assemblies 406, 410 from one another.

FIG. 8 is a diagram including indicators of forces of the components of the SBW energy storage apparatus 106 of FIGS. 1-3 for a CW (right) self-turn of the steering wheel 202 based on energy consumed from (e.g., released by) the constant torque spring 308 and no driver-input hand resistance on the steering wheel 202. In the example of FIG. 8, the constant torque spring 308 has stored energy which creates a feedback CCW 2× Nm torque on the differential carrier 310. The fully unlocked clutch 304 causes the first differential transfer shaft 317 and the spur gear 336 to rotate independent of the spur gear 312. As the constant torque spring 308 unwinds or decompresses to release energy, the feedback CCW 2× Nm torque from the constant torque spring 308 creates feedback CCW × Nm torques at the spider gears 348, 350.

The 1:1 gear ratio between the spur gear 318 and the spur gear 326 causes the feedback CCW × Nm torque of the spider gear 350 to be transferred as feedback CCW × Nm torque from the spur gear 318 to the spur gear 326. In the example of FIG. 8, a feedback CW 2× Nm torque is created at the free-wheel spur gear 328 based on the 1:2 gear ratio between the spur gear 336 and the free-wheel spur gear 328. For example, the × Nm torque applied to the first differential transfer shaft 317 by the constant torque spring 308 is multiplied by two due to the free-wheel spur gear 328 having twice as many teeth as the spur gear 336. Although the spur gear 326 and the free-wheel spur gear 328 rotate in the same direction, the × Nm torque of the spur gear 326 is in the opposite direction of a 2× Nm torque of the spur gear 328 as the torques of the spur gears 326 and 328 resist one another. In the illustrated example, the opposing torques of the spur gear 326 and the free-wheel spur gear 328 produce a feedback CW 1× Nm torque at the steering shaft 204. The steering shaft 204 transfers the feedback CW 1× Nm torque to the steering wheel 202. In the example of FIG. 8, applying the feedback torque originating from the constant torque spring 308 to the steering wheel 202 in the CW direction turns the steering wheel 202 to the right as feedback to a driver that the vehicle 100 is straightening its front wheels 108a, b such as when coming out of a left turn and returning towards a straight path of travel.

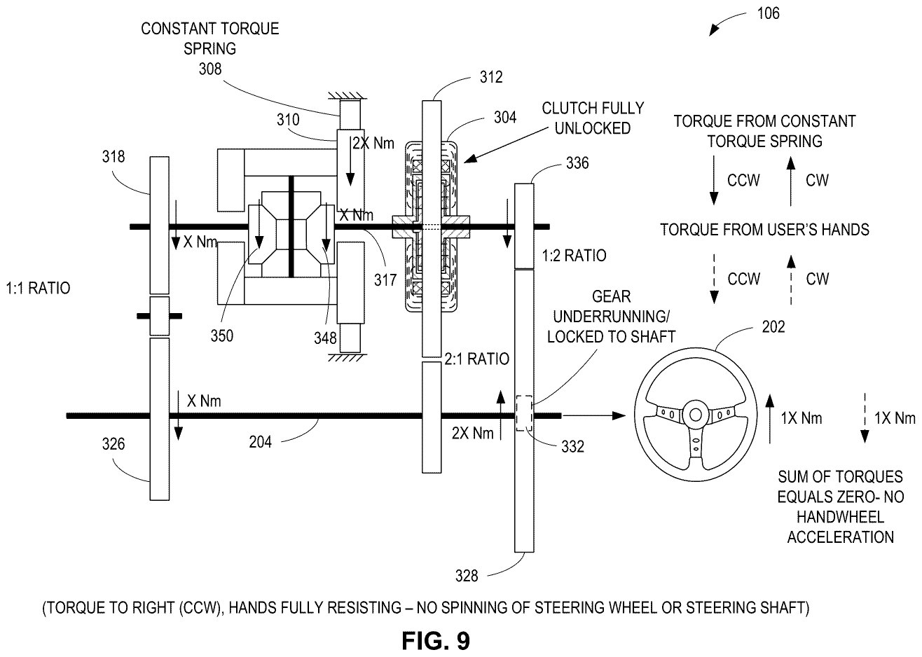

FIG. 9 is a diagram including indicators of forces of the components of the SBW energy storage apparatus 106 of FIGS. 1-3 for a CW torque (torque to right) based on energy consumed from (e.g., released by) the constant torque spring 308 to the steering wheel 202 while a driver's hands are fully resisting the steering wheel 202. The transfer of feedback torque from the constant torque spring 308 to the steering wheel 202 is substantially similar or identical to the transfer of feedback torque described above in connection with FIG. 8. However, in the example of FIG. 9, there is no rotating of the steering wheel 202 and the steering shaft 204 because a driver's hands are fully resisting the steering wheel 202. As such, in the example of FIG. 9, a driver-input hand torque applied by the driver to the steering wheel 202 is shown in the example of FIG. 9 as a CCW 1× Nm torque which counteracts a feedback CW 1× Nm torque to the steering wheel 202 from the SBW energy storage apparatus 106.

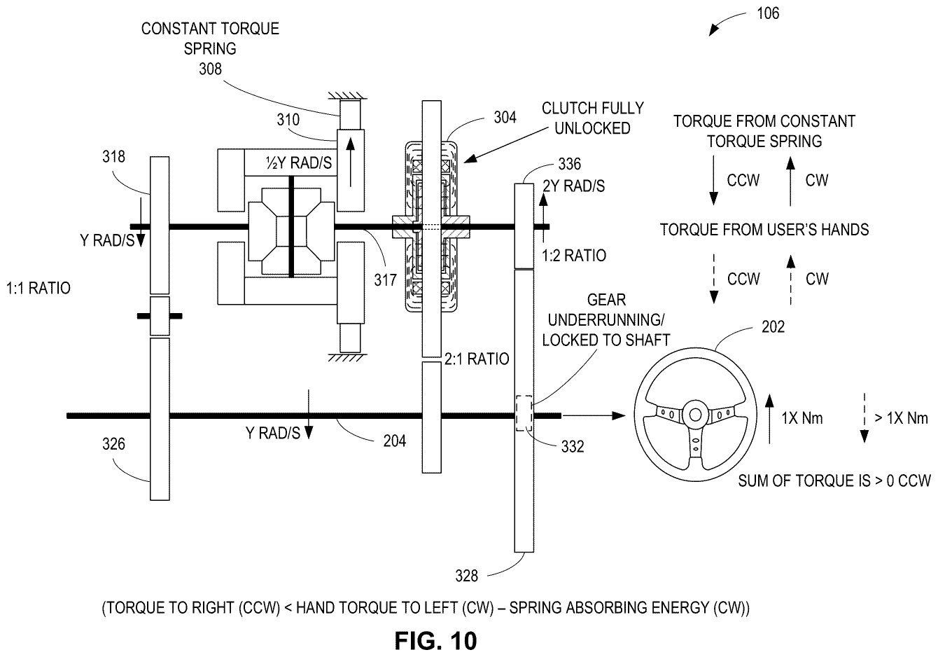

FIG. 10 is a diagram including indicators of forces of the components of the SBW energy storage apparatus 106 of FIGS. 1-3 when energy is absorbed by the constant torque spring 308 based on a feedback CW torque (torque to right) from the SBW energy storage apparatus 106 to the steering wheel 202 that is less than a driver-input CCW hand torque (torque to left) applied to the steering wheel 202. In the example of FIG. 10, the energy absorbed and stored by the constant torque spring 308 is described relative to rotations (e.g., rad/s) of the differential carrier 310 and other components of the SBW energy storage apparatus 106.

As the constant torque spring 308 is compressed based on the CCW driver-input hand torque, the constant torque spring 308 produces feedback torque in the opposite direction based on its mechanical resistance to the compression. This counteracting feedback torque from the constant torque spring 308 propagates through the SBW energy storage apparatus 106 to transfer a feedback CCW 1× Nm torque to the steering wheel 202. However, the feedback CCW 1× Nm torque originating from mechanical resistance of the constant torque spring 308 is overcome by the CCW driver-input hand torque which is shown to be greater than 1× Nm (e.g., >1× Nm) in the example of FIG. 10. This makes the sum of the torques at the steering wheel 202 greater than zero in the CCW direction (e.g., sum of torque>0 CCW at steering wheel). As such, the CCW driver-input hand torque on the steering wheel 202 causes the constant torque spring 308 to move into a compressed state in which the constant torque spring 308 stores energy. In other words, the constant torque spring 308 causes up to 1× Nm torque to be applied as CW feedback to the steering wheel 202 before the constant torque spring 308 moves into the compressed state.

For CCW driver-input hand torques on the steering wheel 202 that are greater than the feedback CW 1× Nm torque from the mechanical resistance of the constant torque spring 308, a driver controls the angle/speed (e.g., rad/s) of the steering wheel 202 as the CCW driver-input hand torque works against the inertia of the gears, shafts, and steering wheel 202 that resist further rotation. As shown in the example of FIG. 10, a driver-input hand torque on the steering wheel 202 that is greater than 1× Nm in the CCW direction (e.g., a left turn) produces a CCW rotation of Y rad/s at the steering shaft 204. The 1:2 gear ratio between the spur gear 336 and the free-wheel spur gear 328 causes the CCW rotation of Y rad/s from the steering shaft 204 to increase to 2Y rad/s at the spur gear 336. The 1:1 gear ratio between the spur gear 318 and the spur gear 326 causes the CCW rotation of Y rad/s from the steering shaft 204 to transfer as Y rad/s to the spur gear 318. A CW rotation of ½Y rad/s is produced at the differential carrier 310 based on an average of the CCW rotation of Y rad/s at the spur gear 318 and the CW rotation of 2Y rad/s at the spur gear 336. This rotation of the differential carrier 310 compresses the constant torque spring 308 causing the constant torque spring 308 to store energy.

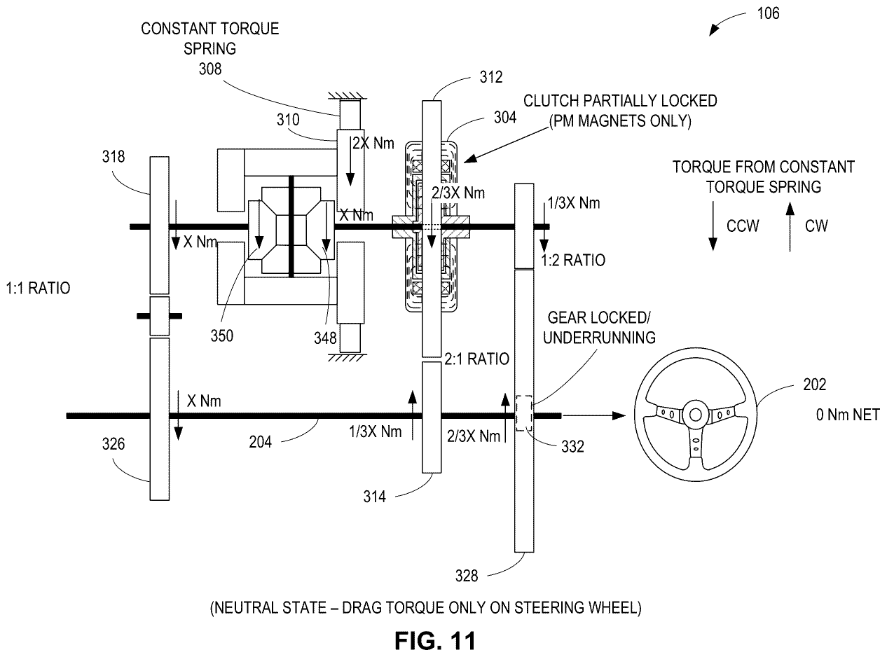

FIG. 11 is a diagram including indicators of forces of the components of the SBW energy storage apparatus 106 of FIGS. 1-3 when the SBW energy storage apparatus 106 and the steering wheel 202 are in a neutral state. In the example of FIG. 11, the clutch 304 is partially locked based on the PM fields 418 created by the permanent magnet 414 without a switchable electric ﬁeld being produced by the electromagnetic coil 416.

In the example of FIG. 11, the constant torque spring 308 has stored energy which creates a feedback CCW 2× Nm torque on the differential carrier 310. This produces feedback CCW × Nm torques at the spider gears 348, 350. The 1:1 gear ratio between the spur gear 318 and the spur gear 326 causes the feedback CCW × Nm torque of the spider gear 350 to be transferred as CCW × NM torque from the spur gear 318 to the spur gear 326. The partially locked state of the clutch 304 causes the feedback × Nm torque from the spider gear 348 to decrease at the spur gear 312 to ⅔× Nm in the CCW direction. The 2:1 gear ratio between the spur gear 312 and the spur gear 314 causes the feedback CCW ⅔× Nm torque from the spur gear 312 to decrease to half the torque (e.g., ⅓× Nm) at the spur gear 314 in the CW direction.

In the example of FIG. 11, the free-wheel spur gear 328 underruns the steering shaft 204 based on the one-way bearing 332. As such, the free-wheel spur gear 328 is in a locked relationship with the steering shaft 204 and rotates with the steering shaft 204. Although the spur gear 326, the spur gear 314, and the free-wheel spur gear 328 rotate in the same direction, the CW ⅓× Nm torque of the spur gear 314 and the CW ⅔× Nm torque of the free-wheel spur gear 328 are in the opposite direction of the CCW × Nm torque of the spur gear 326. As such, the sum of the torques of the spur gear 314 and the free-wheel spur gear 328 (e.g., CW ⅓× Nm torque+CW ⅔× Nm torque=CW × Nm torque) cancel the CCW × Nm torque of the spur gear 326. Such torque cancelation produces a feedback torque of 0 Nm at the steering shaft 204 and the steering wheel 202. Accordingly, the steering wheel 202 does not rotate and remains neutral. The neutral state of the steering wheel 202 in FIG. 11 can be referred to as the steering wheel 202 having drag torque only (e.g., drag torque from resistances between the components of the SBW energy storage apparatus 106).

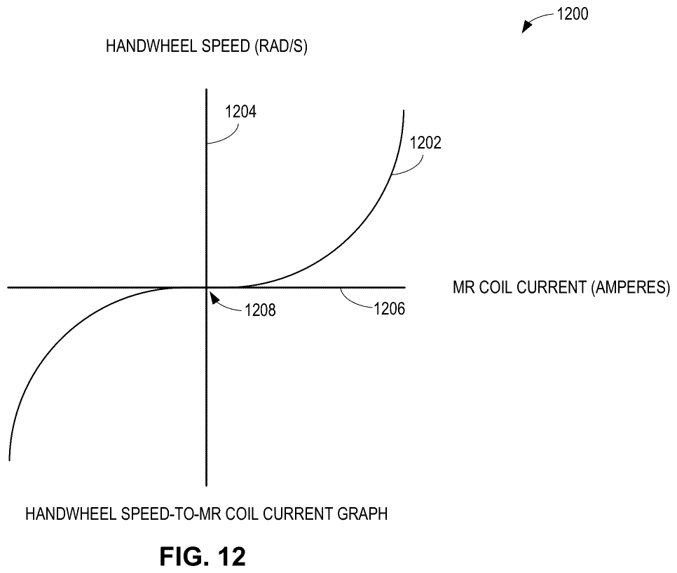

FIG. 12 is an example handwheel speed-to-MR coil current graph 1200 that may be used to control the clutch 304 of FIGS. 3-11. The graph 1200 includes an example line plot 1202 along an example handwheel speed axis (rad/s) 1204 and an example MR coil current axis (amperes) 1206. The handwheel speeds of the handwheel speed axis (rad/s) 1204 represent how fast the steering wheel 202 is permitted to rotate. The MR coil currents of the MR coil current axis (amperes) 1206 represent how much electrical current the steering controller 104 is to apply to the MR fluid 412 to increase or decrease the engagement of the clutch 304. Varying the electrical current along MR coil current axis 1206 to vary the engagement of the clutch 304 allows the steering wheel 202 to rotate faster or slower along the handwheel speed axis 1204.

Coordinate values of the line plot 1202 corresponding to rad/s values of the handwheel speed axis 1204 and ampere values of the MR coil current axis 1206 can be stored in a look-up table in the steering controller 104 or in a memory device that is in circuit with the steering controller 104. Accordingly, the steering controller 104 can access the look-up table to obtain electrical current values of the MR coil current axis 1206 based on how fast the steering wheel 202 should be allowed to rotate. The steering controller 104 can then apply the electrical current values to the MR fluid 412 of the clutch 304 to change the dampening characteristics of the clutch 304 to produce an amount of feedback torque that controls the rotational speed of the steering wheel 202.

An example midpoint 1208 at the intersection of the handwheel speed axis 1204 and the MR coil current axis 1206 is the point at which the permanent magnet 414 in the clutch 304 holds a balance across the differential 306. At that point, the torque in the SBW energy storage apparatus 106 must overcome internal friction and recirculation torque before a torque path between the constant torque spring 308 and the steering wheel 202 is created.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

Example methods, apparatus, systems, and articles of manufacture to implement steer-by-wire energy storage apparatus are disclosed herein. Further examples and combinations thereof include the following:

Example 1 includes an apparatus comprising a steering shaft, a clutch coupled to the steering shaft, a differential coupled to the steering shaft via the clutch, and a torque spring coupled to a carrier of the differential.

Example 2 includes the apparatus of example 1, further including a first gear coupled to the clutch, and a second gear coupled to the steering shaft, the clutch coupled to the steering shaft by the first gear meshing with the second gear.

Example 3 includes the apparatus of one or both of examples 1 and 2, wherein a first end of the differential is coupled to the steering shaft via the clutch and a second end of the differential is coupled to the steering shaft via a gear.

Example 4 includes the apparatus of any one or more of examples 1-3, wherein the gear is a first gear, the apparatus further including a second shaft extending from the second end of the differential, the second shaft coupled to the first gear, an idler gear meshed with the first gear, and a third gear coupled to the steering shaft and meshed with the idler gear.

Example 5 includes the apparatus of any one or more of examples 1-4, further including a first gear, a one-way bearing coupling the first gear to the steering shaft, a second shaft extending from the clutch, and a second gear coupled to the second shaft and meshed with the first gear.

Example 6 includes the apparatus of any one or more of examples 1-5, further including a handwheel coupled to the steering shaft.

Example 7 includes the apparatus of any one or more of examples 1-6, wherein the clutch is a magnetorheological clutch.

Example 8 includes a steer-by-wire system comprising a steering wheel, a clutch coupled to the steering wheel, a differential coupled to the steering wheel via the clutch, a steering controller coupled to the steering wheel, and a road wheel actuator to communicate with the steering controller.

Example 9 includes the steer-by-wire system of example 8, further including a steering shaft, a first spur gear coupled to the clutch, and a second spur gear coupled to the steering shaft, the clutch coupled to the steering wheel based on the first spur gear meshed with the second spur gear.

Example 10 includes the steer-by-wire system of one or both of examples 8 and 9, wherein a first end of the differential is coupled to the steering wheel via the clutch and a second end of the differential is coupled to the steering wheel via a shaft extending from the differential and a spur gear coupled to the shaft.

Example 11 includes the steer-by-wire system of any one or more of examples 8-10, wherein the shaft is a first shaft and the spur gear is a first spur gear, the steer-by-wire system further including an idler gear meshed with the first spur gear, a steering shaft coupled to the steering wheel, and a second spur gear coupled to the steering shaft and meshed with the idler gear.

Example 12 includes the steer-by-wire system of any one or more of examples 8-11, further including a first spur gear, a steering shaft between the first spur gear and the steering wheel, a one-way bearing coupling the first spur gear to the steering shaft, a second spur gear meshed with the first spur gear, and a second shaft between the second spur gear and the clutch.

Example 13 includes the steer-by-wire system of any one or more of examples 8-12, further including a constant torque spring coupled to a carrier of the differential.

Example 14 includes the steer-by-wire system of any one or more of examples 8-13, wherein the clutch is a magnetorheological clutch.

Example 15 includes the steer-by-wire system of any one or more of examples 8-14, wherein the magnetorheological clutch is in circuit with the steering controller.

Example 16 includes an apparatus comprising a differential having a differential carrier, a torque spring having a first end coupled to the differential carrier and a second end coupled to a structure separate from the differential carrier, the torque spring to receive energy from the differential carrier, the torque spring to store the energy, and a clutch coupled to the differential, the clutch to control transfer of the energy between a steering wheel and the torque spring.

Example 17 includes the apparatus of example 16, wherein the clutch is a magnetorheological clutch.

Example 18 includes the apparatus of one or both of examples 16 and 17, wherein the magnetorheological clutch is to receive a voltage to control a damping force created by the magnetorheological clutch, the damping force to control the transfer of the energy between the steering wheel and the torque spring.

Example 19 includes the apparatus of any one or more of examples 16-18, further including a first spur gear, a steering shaft between the steering wheel and the first spur gear, a one-way bearing coupling the first spur gear to the steering shaft, a second spur gear meshed with the first spur gear, and a second shaft between the second spur gear and the clutch.

Example 20 includes the apparatus of any one or more of examples 16-19, further including a third spur gear coupled to the differential via a third shaft, an idler gear meshed with the third spur gear, and a fourth spur gear coupled to the steering shaft and meshed with the idler gear.

From the foregoing, it will be appreciated that example systems, apparatus, articles of manufacture, and methods have been disclosed to implement a SWB energy storage apparatus. Disclosed systems, apparatus, articles of manufacture, and methods increase the efficiency of vehicles and of SBW systems in vehicles. For example, examples disclosed herein have low voltage and electrical current requirements compared to motor-based solutions to provide steering feedback to drivers in SBW systems. Examples disclosed herein use mechanical damping based on a constant torque spring, a differential, and a clutch instead of electronic damping using electrical motors. Examples disclosed herein provide position control without relying on an electrical motor which reduces power requirements and complexities of parts in a SBW system. Disclosed systems, apparatus, articles of manufacture, and methods are accordingly directed to one or more enhancement(s) in the operation of a machine such as a vehicle or other electronic and/or mechanical device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
a steering shaft;
a clutch coupled to the steering shaft;
a differential coupled to the steering shaft via the clutch; and
a torque spring coupled to a carrier of the differential.

2. The apparatus of claim 1, further including:
a first gear coupled to the clutch; and
a second gear coupled to the steering shaft, the clutch coupled to the steering shaft by the first gear meshing with the second gear.

3. The apparatus of claim 1, wherein a first end of the differential is coupled to the steering shaft via the clutch and a second end of the differential is coupled to the steering shaft via a gear.

4. The apparatus of claim 3, wherein the gear is a first gear, the apparatus further including:
a second shaft extending from the second end of the differential, the second shaft coupled to the first gear;
an idler gear meshed with the first gear; and
a third gear coupled to the steering shaft and meshed with the idler gear.

5. The apparatus of claim 1, further including:
a first gear;
a one-way bearing coupling the first gear to the steering shaft;
a second shaft extending from the clutch; and
a second gear coupled to the second shaft and meshed with the first gear.

6. The apparatus of claim 1, further including a handwheel coupled to the steering shaft.

7. The apparatus of claim 1, wherein the clutch is a magnetorheological clutch.

8. A steer-by-wire system comprising:
a steering wheel;
a clutch coupled to the steering wheel;
a differential coupled to the steering wheel via the clutch;
a steering controller coupled to the steering wheel; and
a road wheel actuator to communicate with the steering controller.

9. The steer-by-wire system of claim 8, further including:
a steering shaft;
a first spur gear coupled to the clutch; and
a second spur gear coupled to the steering shaft, the clutch coupled to the steering wheel based on the first spur gear meshed with the second spur gear.

10. The steer-by-wire system of claim 8, wherein a first end of the differential is coupled to the steering wheel via the clutch and a second end of the differential is coupled to the steering wheel via a shaft extending from the differential and a spur gear coupled to the shaft.

11. The steer-by-wire system of claim 10, wherein the shaft is a first shaft and the spur gear is a first spur gear, the steer-by-wire system further including:
an idler gear meshed with the first spur gear;
a steering shaft coupled to the steering wheel; and
a second spur gear coupled to the steering shaft and meshed with the idler gear.

12. The steer-by-wire system of claim 8, further including:
a first spur gear;
a steering shaft between the first spur gear and the steering wheel;
a one-way bearing coupling the first spur gear to the steering shaft;
a second spur gear meshed with the first spur gear; and
a second shaft between the second spur gear and the clutch.

13. The steer-by-wire system of claim 8, further including a constant torque spring coupled to a carrier of the differential.

14. The steer-by-wire system of claim 8, wherein the clutch is a magnetorheological clutch.

15. The steer-by-wire system of claim 14, wherein the magnetorheological clutch is in circuit with the steering controller.

16. An apparatus comprising:
a differential having a differential carrier;
a torque spring having a first end coupled to the differential carrier and a second end coupled to a structure separate from the differential carrier, the torque spring to receive energy from the differential carrier, the torque spring to store the energy; and
a clutch coupled to the differential, the clutch to control transfer of the energy between a steering wheel and the torque spring.

17. The apparatus of claim 16, wherein the clutch is a magnetorheological clutch.

18. The apparatus of claim 17, wherein the magnetorheological clutch is to receive a voltage to control a damping force created by the magnetorheological clutch, the damping force to control the transfer of the energy between the steering wheel and the torque spring.

19. The apparatus of claim 16, further including:
a first spur gear;
a steering shaft between the steering wheel and the first spur gear;
a one-way bearing coupling the first spur gear to the steering shaft;
a second spur gear meshed with the first spur gear; and
a second shaft between the second spur gear and the clutch.

20. The apparatus of claim 19, further including:
a third spur gear coupled to the differential via a third shaft;
an idler gear meshed with the third spur gear; and
a fourth spur gear coupled to the steering shaft and meshed with the idler gear.
